(19) United States
(12) Patent Application Publication
(10) Pub. No.: US 2014/0335245 A1
(43) Pub. Date: Nov. 13, 2014

(54) MEAT PRODUCT

(71) Applicant: DUPONT NUTRITION BIOSCIENCES APS, Copenhagen (DK)

(72) Inventors: Russell Lanzrath, New Century, KS (US); Wigberto Nunez Maisonet, New Century, KS (US)

(21) Appl. No.: 14/310,666

(22) Filed: Jun. 20, 2014

Related U.S. Application Data
(63) Continuation-in-part of application No. PCT/IB2012/057277, filed on Dec. 13, 2012.
(60) Provisional application No. 61/578,964, filed on Dec. 22, 2011.

(30) Foreign Application Priority Data
Feb. 8, 2012 (GB) 1202206.7

(51) Int. Cl. A23B 4/20; A23L 1/314

(52) U.S. Cl. CPC A23B 4/20; A23L 1/31418
USPC 426/268; 426/542; 426/545; 426/544; 426/262

(57) ABSTRACT

The present invention provides a meat product comprising (a) uncooked meat; wherein the uncooked meat has been contacted with (b) acerola [Malpighia emarginata] berry, acerola [Malpighia emarginata] berry extract or mixtures thereof (c) green tea [Camellia sinensis], green tea [Camellia sinensis] extract or mixtures thereof.

### RELATED APPLICATIONS AND INCORPORATION BY REFERENCE

This application is a continuation-in-part application of international patent application Serial No. PCT/IB2012/057277 filed Dec. 13, 2012, which published as PCT Publication No. WO 2013/093730 on Jun. 27, 2013, which claims the benefit of U.S. provisional application Ser. No. 61/578,964 filed Dec. 22, 2011 and which claims benefit of United Kingdom patent application Serial No. 1202206.7 filed Feb. 8, 2012.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a meat product that is less susceptible to discoloration during storage.

### BACKGROUND OF THE INVENTION

As discussed in Mancini et al, Meat Science 71 (2005) 100-121, meat purchasing decisions are influenced by colour more than any other quality factor because consumers use discoloration as an indicator of freshness and wholesomeness. As a result, nearly 15% of retail beef is discounted in price due to surface discoloration, which corresponds to annual revenue losses of $1 billion (Smith, Belk, Sofos, Tatum, & Williams, 2000, Economic implications of improved color stability in beef In E. A. Decker, C. Faustman, & C. J. Lopez-Bote (Eds.), Antioxidants in muscle foods: Nutritional strategies to improve quality (pp. 397-426). New York: Wiley Interscience).

There is an increasing need to develop economical, natural and effective preservative systems to reduce discoloration of meat and to meet the public demand for convenient, natural, safe, healthy, good quality products with guaranteed shelf life. Moreover there is a desire to provide this advantage by use of material derived from plants. Such plant extracts are considered to be desirable because they are regarded as being natural. Moreover from a regulatory point of view, because of long term usage, plant extracts typically have GRAS (generally regarded as safe) status. There is also a continuing to desire to reduce discoloration utilising lower amounts of active materials. Thus there is a need to provide new active materials to reduce discoloration or new more effective combinations of active materials to reduce discoloration.

Citation or identification of any document in this application is not an admission that such document is available as prior art to the present invention.

### SUMMARY OF THE INVENTION

Despite their natural origins, it is desirable that active products from plants be used in the lowest possible amounts. This is desirable not only for reasons of cost but also to meet consumer desire to minimise the amount of ‘additives’ in foodstuffs. Moreover, many plant materials have an associated taste. Therefore in many demanding food applications reduction of the amount of material from plant origin is advantageous.

These and other aims are addressed by the present invention.

In one aspect the present invention provides a meat product which may comprise (a) uncooked meat; (b) acerola [Malpighia emarginata] berry, acerola [Malpighia emarginata] berry extract or mixtures thereof; and (c) green tea [Camellia sinensis], green tea [Camellia sinensis] extract or mixtures thereof.

In one aspect the present invention provides a process for preventing or inhibiting the discoloration of uncooked meat, the process which may comprise the step of contacting (a) uncooked meat; with (b) acerola [Malpighia emarginata] berry, acerola [Malpighia emarginata] berry extract or mixtures thereof; and (c) green tea [Camellia sinensis], green tea [Camellia sinensis] extract or mixtures thereof.

In one aspect the present invention provides use of (b) acerola [Malpighia emarginata] berry, acerola [Malpighia emarginata] berry extract or mixtures thereof; and (c) green tea [Camellia sinensis], green tea [Camellia sinensis] extract or mixtures thereof; for preventing and/or inhibiting the discoloration of uncooked meat.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 shows a graph depicting Minolta a* values.

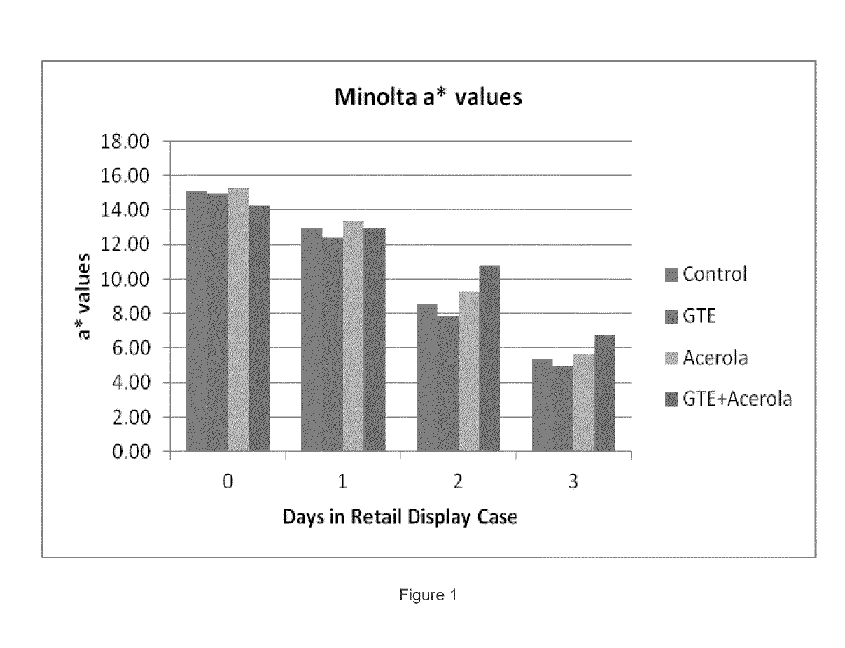

FIG. 2 shows results from treatments analyzed according to the proportion levels of components. A mixture design was utilized to create inverse proportions of the two components.

FIG. 3 indicates the synergistic interaction of the components. The combination of both components always equal 100%. The r-square of the linear regression explains 88.7% of the variability whereas the r-square of the quadratic regression explains 97.4% of the variability. The quadratic regression has a better fit to the data that was collected from the trial. Since the regressions are not parallel, there is an interaction that is taking place. There is a strong positive interaction around the proportion of 0.5 which indicates a positive interaction of acerola extract and green tea extract. This relates to the blend ratio of 50% acerola extract and 50% green tea extract performing the best for this application.

FIG. 4 displays the Hunter a values for the blend vs. the individual components. The blend has a higher Hunter a value after day 3, which is important for shelf life extension.

FIG. 5 details the difference in Hunter a values from the control treatment. The difference is the greatest at day 4 as that is the point in the shelf life where the treatments have the largest difference in Hunter a value from the control. On day 6, 7 & 8 the blend has a higher Hunter a value than the individual components combined which indicates that there is a synergistic interaction when the components are added together in the blend. The p-value from the chart shows that there is a significant difference on day 2 through 8. On day 2 through 5, there is a significant difference that Applicants can say the individual components added together have a higher Hunter a value than the blend. On day 6 through 8, there is a significant difference which Applicants can say that the blend has a higher Hunter a value than the individual components added together. Since Applicants are wanting to increase the shelf life of the fresh ground beef, the Hunter a values at the end of the shelf life are more important than at the beginning of the shelf life.

FIG. 6 shows a graph depicting Hunter a* values of ground beef.

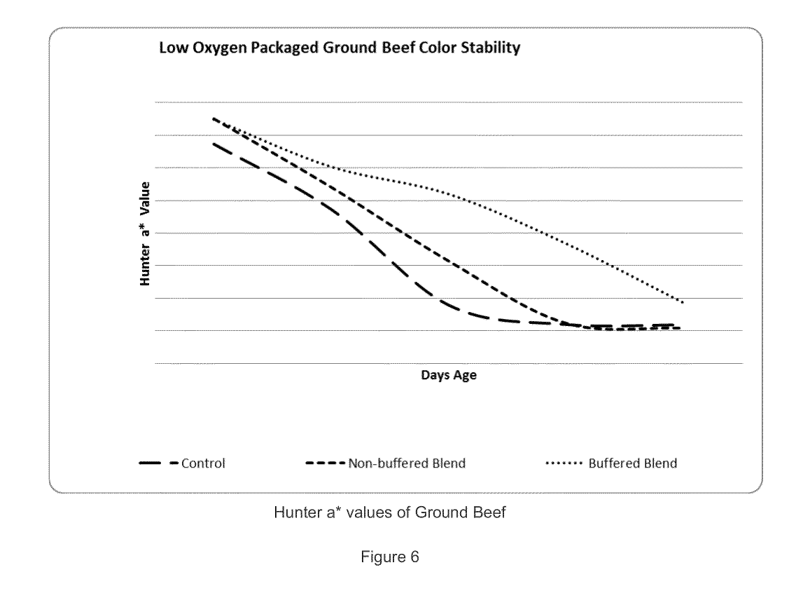

### DETAILED DESCRIPTION OF THE INVENTION

The present invention provides a synergistic combination of components for preventing or inhibiting the discoloration of uncooked meat. This combination of components allows lower levels of constituent active agents, such as lower levels of (b) acerola [Malpighia emarginata] berry, acerola [Malpighia emarginata] berry extract or mixtures thereof; and/or (c) green tea [Camellia sinensis], green tea [Camellia sinensis] extract or mixtures thereof, to be used to provide effective action and prevent the discoloration of uncooked meat. This is particularly important in food applications where reduction of dosage is desired for commercial and regulatory reasons. Synergistic interaction is of particular interest because of the fact that with relatively small amounts of different compounds, thereby minimizing the impact of their negative properties, a relatively large discoloration preventative effect can be achieved.

With regard to the specific material utilised in the present invention, namely (b) acerola [Malpighia emarginata] berry, acerola [Malpighia emarginata] berry extract or mixtures thereof; and (c) green tea [Camellia sinensis], green tea [Camellia sinensis] extract or mixtures thereof, at least green tea extract has some unfavourable properties. For example, the use of green tea [Camellia sinensis] extract in high concentrations may face regulatory restrictions as acceptable daily intake (ADI) values of component catechins need to be considered. The synergistic action identified in the present application allows for the levels of green tea or green tea extract to be reduced.

By the terms “preventing or inhibiting” or “prevent or inhibit” discoloration it is meant that (i) the period before discoloration begins is increased, (ii) the extent of discoloration over a given period of time is decreased, (iii) the time before a certain discoloration occurs is increased or (iv) a combination of (i), (ii) and (iii). Discoloration may be readily determined by one skilled in the art based on the common general knowledge. In one aspect discoloration is measured in accordance with the methodology given in the examples.

Applicants have found that the present invention is particularly effective at preventing or inhibiting discoloration during extended storage. The present invention provides a composition which can prevent or inhibit discoloration for periods during which noticeable and significant discoloration would occur in no treated meat. In one aspect the present invention prevents or inhibits discoloration of uncooked meat after a period of at least 2 days, such as at least 3 days, such as at least 4 days, such as at least 5 days, such as at least 6 days, such as at least 7 days, such as at least 8 days, such as at least 9 days, such as at least 10 days. Applicants have found that over short period of storage, meats not treated with the present composition may in fact discolour less rapidly than treated meats. However, after the passing of this short period, for example 2, 3, 4, 5 or 6 days, the untreated meats rapidly discolour while the treated meats do not. Thus after the storage period of for example 2, 3, 4, 5 or 6 days, the treated meats are found to have better colour. As there is a desire to store meats for extended periods, this is advantageous.

As discussed herein the need product of the present invention may comprise uncooked meat. It will be understood by one skilled in the art that uncooked meat is animal flesh which has not been subjected to an elevated temperature which results in significant modification of the protein structure. The uncooked meat of the present invention may be any animal meat. The problems of discoloration of uncooked meat are particularly pronounced in respect of red meat. This is believed to be result of the degradation of myoglobin. Thus in one preferred aspect the uncooked meat is red meat.

As stated above, the uncooked meat may be from any animal. In one preferred aspect the uncooked meat is selected from pork, beef, lamb, poultry and in particular chicken and turkey, veal, rabbit, venison, horse, goat, and fish (including salmon and trout). In one preferred aspect the uncooked meat is selected from pork, beef, lamb, chicken and turkey. In one aspect the uncooked meat is a white meat. In one preferred aspect the uncooked meat is a red meat.

The uncooked meat of the present invention may be in the form of whole muscle or it may be part of a whole muscle. The meat may be physically modified, for example by cutting, chopping, mincing or grinding. Thus the uncooked meat may be selected from whole muscle, ground muscle or minced muscle. The problems of discoloration are particularly pronounced in respect of minced uncooked meat. This is because of the high surface area to weight ratio of minced meat compared to whole muscle. Thus in one preferred aspect, the uncooked meat of the present invention is minced uncooked meat.

The problems of discoloration are particularly problematic in respect of the storage of beef. Thus in one preferred aspect, the uncooked meat is uncooked beef. Yet further the problems of discoloration of uncooked minced beef are significant to the industry. Therefore in a highly preferred aspect the uncooked meat is minced beef.

The present invention may be utilised in respect of the discoloration of a wide range of meats irrespective of their fat content i.e. irrespective of their “leanness”. However, discoloration may be particularly pronounced in respect of lean meat. This is not only because of the high myoglobin content of these materials but also their commercial value compared to meat with high fat content. In one preferred aspect the uncooked meat has a fat content of less than 50 wt. % based on the weight of the uncooked meat. In one preferred aspect the uncooked meat has a fat content of less than 40 wt. % based on the weight of the uncooked meat. In one preferred aspect the uncooked meat has a fat content of less than 30 wt. % based on the weight of the uncooked meat. In one preferred aspect the uncooked meat has a fat content of less than 20 wt. % based on the weight of the uncooked meat. In one preferred aspect the uncooked meat has a fat content of less than 10 wt. % based on the weight of the uncooked meat. In one preferred aspect the uncooked meat is beef having a fat content of less than 50 wt. % based on the weight of the uncooked meat. In one preferred aspect the uncooked meat is beef having a fat content of less than 40 wt. % based on the weight of the uncooked meat. In one preferred aspect the uncooked meat is beef having a fat content of less than 30 wt. % based on the weight of the uncooked meat. In one preferred aspect the uncooked meat is beef having a fat content of less than 20 wt. % based on the weight of the uncooked meat. In one preferred aspect the uncooked meat is beef having a fat content of less than 10 wt. % based on the weight of the uncooked meat. In one preferred aspect the uncooked meat is beef having a fat content of less than 7% wt. % based on the weight of the uncooked meat.

As discussed herein, the present meat product contains acerola [Malpighia emarginata] berry, acerola [Malpighia emarginata] berry extract or mixtures thereof. Acerola berry is a fruit of Malpighia enmarginata. Malpighia emarginata is a tropical fruit-bearing shrub or small tree in the family Malpighiaceae. Common names include acerola, Barbados cherry, West Indian cherry and wild crapemyrtle. It is known for being extremely rich in vitamin C although it also contains vitamins A, B₁, B₂ and B₃ as well as carotenoids and bioflavonoids. Vitamin C produced by the acerola fruit is better absorbed by human organisms than synthetic ascorbic acid suggesting that the acerola berries provide more than a natural source of synthetic products.

It will be appreciated by one skilled in the art that by the term “extract” or “extracts” it is meant any constituent of the plant which may be isolated from the whole plant.

The acerola berry may be provided in the form of the berry itself or part thereof or may be provided in the form of an extract of the acerola berry. In one preferred aspect the meat product may comprise the acerola [Malpighia emarginata] berry in the form of an extract.

The acerola [Malpighia emarginata] berry or acerola [Malpighia emarginata] berry extract may be present in any suitable amount to achieve the desired effect of preventing or reducing discoloration. It is appreciated by one skilled in the art that amounts of acerola [Malpighia emarginata] berry or acerola [Malpighia emarginata] berry extract are typically denoted by the amount of natural ascorbic acid provided by the acerola [Malpighia emarginata] berry or acerola [Malpighia emarginata] berry extract. Suitable amounts of berry or extract for use in the present invention are given below based on the amount of natural ascorbic acid. It will be understood that the present invention however still requires the presence of acerola [Malpighia emarginata] berry or acerola [Malpighia emarginata] berry extract and a synthetic or alternative sources of ascorbic acid are not encompassed within these amounts. In one preferred aspect the acerola [Malpighia emarginata] berry extract is present in an amount to provide ascorbic acid in an amount of at least 1 ppm based on the total weight of the meat product, such as in an amount of at least 2 ppm based on the total weight of the meat product, such as in an amount of at least 3 ppm based on the total weight of the meat product, such as in an amount of at least 4 ppm based on the total weight of the meat product, such as in an amount of at least 5 ppm based on the total weight of the meat product, such as in an amount of at least 10 ppm based on the total weight of the meat product, such as in an amount of at least 25 ppm based on the total weight of the meat product, such as in an amount of at least 50 ppm based on the total weight of the meat product, such as in an amount of at least 75 ppm based on the total weight of the meat product, such as in an amount of at least 100 ppm based on the total weight of the meat product, such as in an amount of at least 110 ppm based on the total weight of the meat product, such as in an amount of at least 120 ppm based on the total weight of the meat product, such as in an amount of at least 140 ppm based on the total weight of the meat product, such as in an amount of at least 160 ppm based on the total weight of the meat product.

A maximum amount of acerola [Malpighia emarginata] berry or acerola [Malpighia emarginata] berry extract may be determined by one skilled in the art based on desired effect, taste and any regulatory requirements. As noted above it is appreciated by one skilled in the art that amounts of acerola [Malpighia emarginata] berry or acerola [Malpighia emarginata] berry extract are typically denoted by the amount of natural ascorbic acid provided by the acerola [Malpighia enmarginata] berry or acerola [Malpighia emarginata] berry extract. In one preferred aspect the acerola [Malpighia emarginata] berry extract is present in an amount to provide ascorbic acid in an amount of no greater than 2000 ppm based on the total weight of the meat product, such as in an amount of no greater than 1500 ppm based on the total weight of the meat product, such as in an amount of no greater than 1000 ppm based on the total weight of the meat product, such as in an amount of no greater than 800 ppm based on the total weight of the meat product, such as in an amount of no greater than 600 ppm based on the total weight of the meat product, such as in an amount of no greater than 500 ppm based on the total weight of the meat product, such as in an amount of no greater than 400 ppm based on the total weight of the meat product, such as in an amount of no greater than 300 ppm based on the total weight of the meat product, such as in an amount of no greater than 200 ppm based on the total weight of the meat product, such as in an amount of no greater than 100 ppm based on the total weight of the meat product, such as in an amount of no greater than 75 ppm based on the total weight of the meat product, such as in an amount of no greater than 50 ppm based on the total weight of the meat product, such as in an amount of no greater than 40 ppm based on the total weight of the meat product, such as in an amount of no greater than 30 ppm based on the total weight of the meat product, such as in an amount of no greater than 20 ppm based on the total weight of the meat product, such as in an amount of no greater than 10 ppm based on the total weight of the meat product.

Preferred amounts of acerola [Malpighia emarginata] berry extract are in an amount to provide ascorbic acid in an amount of from 5 to 2000 ppm based on the total weight of the meat product, preferably from 10 to 2000 ppm based on the total weight of the meat product, preferably from 25 to 1500 ppm based on the total weight of the meat product, preferably from 50 to 1000 ppm based on the total weight of the meat product, preferably from 75 to 800 ppm based on the total weight of the meat product, preferably from 100 to 600 ppm based on the total weight of the meat product, preferably from 100 to 500 ppm based on the total weight of the meat product, preferably from 5 to 400 ppm based on the total weight of the meat product, preferably from 100 to 400 ppm based on the total weight of the meat product, preferably from 100 to 300 ppm based on the total weight of the meat product, preferably from 100 to 200 ppm based on the total weight of the meat product, preferably from 150 to 200 ppm based on the total weight of the meat product, preferably from 150 to 190 ppm based on the total weight of the meat product, preferably approximately 170 ppm based on the total weight of the meat product.

Preferred amounts of acerola [Malpighia emarginata] berry extract are in an amount to provide ascorbic acid in an amount of from 1 to 2000 ppm based on the total weight of the meat product, preferably from 1 to 1500 ppm based on the total weight of the meat product, preferably from 1 to 1000 ppm based on the total weight of the meat product, preferably from 1 to 800 ppm based on the total weight of the meat product, preferably from 1 to 600 ppm based on the total weight of the meat product, preferably from 1 to 500 ppm based on the total weight of the meat product, preferably from 1 to 400 ppm based on the total weight of the meat product, preferably from 1 to 300 ppm based on the total weight of the meat product, preferably from 1 to 200 ppm based on the total weight of the meat product, preferably from 1 to 150 ppm based on the total weight of the meat product, preferably from 1 to 100 ppm based on the total weight of the meat product, preferably from 1 to 75 ppm based on the total weight of the meat product, preferably from 1 to 50 ppm based on the total weight of the meat product, preferably from 1 to 40 ppm based on the total weight of the meat product, preferably from 1 to 30 ppm based on the total weight of the meat product, preferably from 1 to 20 ppm based on the total weight of the meat product, preferably from 1 to 10 ppm based on the total weight of the meat product, preferably from 2 to 8 ppm based on the total weight of the meat product, preferably approximately 5 ppm based on the total weight of the meat product.

As discussed herein the meat product may comprise green tea [Camellia sinensis], green tea [Camellia sinensis] extract or mixtures thereof. It will be understood by one skilled in the art that all references herein to green tea extract means an extract from a plant of the species Camellia sinensis.

It will be appreciated by one skilled in the art that by the term “extract” or “extracts” it is meant any constituent of the plant which may be isolated from the whole plant.

In a preferred aspect by the term green tea “extract” or “extracts” of it is meant a leaf of the plant or a constituent which may be isolated from the leaf of whole plant.

The green team may be provided in the form of the green tea leaf itself or part thereof or may be provided in the form of an extract of the green tea. In one preferred aspect the meat product may comprise the green tea [Camellia sinensis] in the form of an extract.

In one preferred aspect the green tea extract is a tea polyphenol. Preferably the green tea extract is a catechin. In a highly preferred aspect the green tea extract is a compound selected from

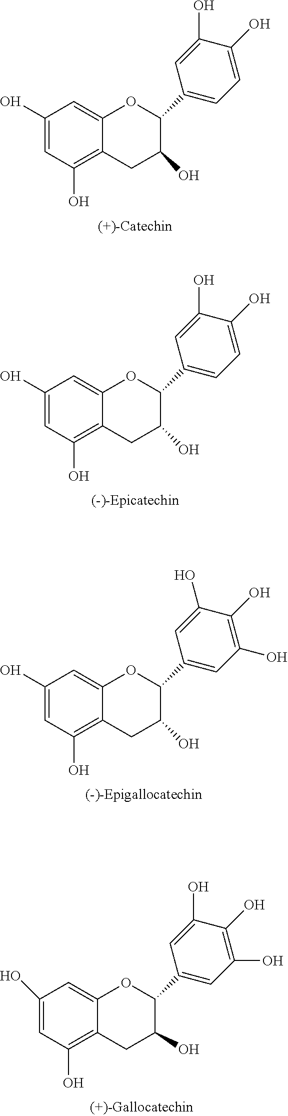 [SMILES: Oc1cc(O)c2c(c1)O[C@H](c1ccc(O)c(O)c1)[C@@H](O)C2 ; Oc1cc(O)c2c(c1)O[C@H](c1ccc(O)c(O)c1)[C@H](O)C2 ; Oc1cc(O)c2c(c1)O[C@H](c1cc(O)c(O)c(O)c1)[C@H](O)C2 ; Oc1cc(O)c2c(c1)O[C@H](c1cc(O)c(O)c(O)c1)[C@@H](O)C2]

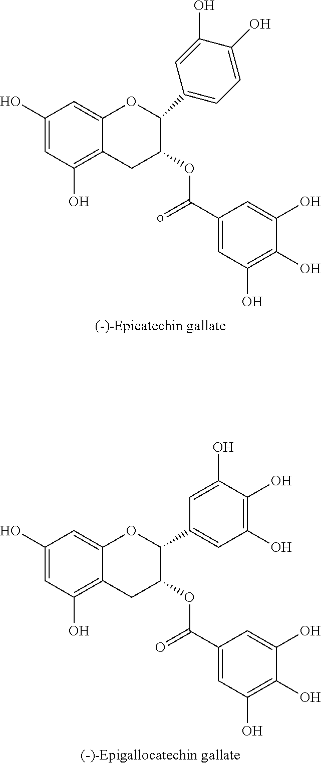

and mixtures thereof. These six compounds are referred to herein as green tea catechins or green tea extract catechins. Green tea extract contains these six catechins in a combined amount of approximately 75 wt % based on the green tea extract.

The green tea [Camellia sinensis] or green tea [Camellia sinensis] extract may be present in any suitable amount to achieve the desired effect of preventing or reducing discoloration. It is appreciated by one skilled in the art that amounts of green tea [Camellia sinensis] or green tea [Camellia sinensis] extract are typically denoted by the amount of catechins provided by the green tea [Camellia sinensis] or green tea [Camellia sinensis] extract. Suitable amounts of green tea or extract for use in the present invention are given below based on the amount of catechins. It will be understood that the present invention however still requires the presence of green tea [Camellia sinensis] or green tea [Camellia sinensis] extract and synthetic or alternative sources of catechins are not encompassed within these amounts. In one preferred aspect the green tea [Camellia sinensis] extract is present in an amount to provide catechins in an amount of at least 10 ppm based on the total weight of the meat product, such as in an amount of at least 20 ppm based on the total weight of the meat product, such as in an amount of at least 30 ppm based on the total weight of the meat product, such as in an amount of at least 40 ppm based on the total weight of the meat product, such as in an amount of at least 50 ppm based on the total weight of the meat product, such as in an amount of at least 60 ppm based on the total weight of the meat product, such as in an amount of at least 70 ppm based on the total weight of the meat product, such as in an amount of at least 80 ppm based on the total weight of the meat product, such as in an amount of at least 90 ppm based on the total weight of the meat product, such as in an amount of at least 100 ppm based on the total weight of the meat product, such as in an amount of at least 125 ppm based on the total weight of the meat product, such as in an amount of at least 150 ppm based on the total weight of the meat product, such as in an amount of at least 175 ppm based on the total weight of the meat product, such as in an amount of at least 200 ppm based on the total weight of the meat product, such as in an amount of at least 225 ppm based on the total weight of the meat product.

A maximum amount of green tea [Camellia sinensis] or green tea [Camellia sinensis] extract may be determined by one skilled in the art based on desired effect, taste and any regulatory requirements. As discussed herein, it is appreciated by one skilled in the art that amounts of green tea [Camellia sinensis] or green tea [Camellia sinensis] extract are typically denoted by the amount of catechins provided by the green tea [Camellia sinensis] or green tea [Camellia sinensis] extract. In one preferred aspect the green tea [Camellia sinensis] extract is present in an amount to provide catechins in an amount of no greater than 2000 ppm based on the total weight of the meat product, preferably in an amount of no greater than 1500 ppm based on the total weight of the meat product, preferably in an amount of no greater than 1000 ppm based on the total weight of the meat product, preferably in an amount of no greater than 800 ppm based on the total weight of the meat product, preferably in an amount of no greater than 600 ppm based on the total weight of the meat product, preferably in an amount of no greater than 500 ppm based on the total weight of the meat product, preferably in an amount of no greater than 400 ppm based on the total weight of the meat product, preferably in an amount of no greater than 300 ppm based on the total weight of the meat product, preferably in an amount of no greater than 200 ppm based on the total weight of the meat product, preferably in an amount of no greater than 100 ppm based on the total weight of the meat product.

Preferred amounts of green tea [Camellia sinensis] extract are to provide catechins in an amount of from 10 to 2000 ppm based on the total weight of the meat product, preferably from 25 to 1500 ppm based on the total weight of the meat product, preferably from 50 to 1000 ppm based on the total weight of the meat product, preferably from 50 to 800 ppm based on the total weight of the meat product, preferably from 50 to 600 ppm based on the total weight of the meat product, preferably from 50 to 500 ppm based on the total weight of the meat product, preferably from 50 to 400 ppm based on the total weight of the meat product, preferably from 50 to 300 ppm based on the total weight of the meat product, preferably from 50 to 200 ppm based on the total weight of the meat product, preferably from 50 to 150 ppm based on the total weight of the meat product, preferably from 50 to 100 ppm based on the total weight of the meat product, preferably from 100 to 300 ppm based on the total weight of the meat product, preferably from 150 to 300 ppm based on the total weight of the meat product, preferably from 200 to 300 ppm based on the total weight of the meat product, preferably approximately 225 ppm based on the total weight of the meat product.

In one aspect the preferably the meat product may comprise green tea extract catechins, namely

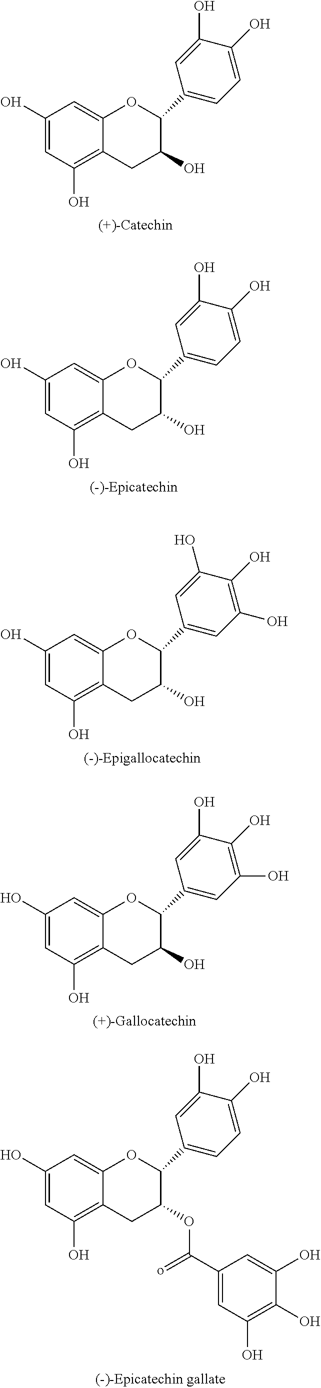

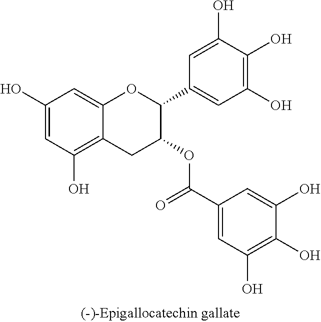 [SMILES: O=C(O[C@@H]1Cc2c(O)cc(O)cc2O[C@@H]1c1cc(O)c(O)c(O)c1)c1cc(O)c(O)c(O)c1]

in a combined amount of at least 10 ppm based on the total weight of the meat product, such as in an amount of at least 20 ppm based on the total weight of the meat product, such as in an amount of at least 30 ppm based on the total weight of the meat product, such as in an amount of at least 40 ppm based on the total weight of the meat product, such as in an amount of at least 50 ppm based on the total weight of the meat product, such as in an amount of at least 60 ppm based on the total weight of the meat product, such as in an amount of at least 70 ppm based on the total weight of the meat product, such as in an amount of at least 80 ppm based on the total weight of the meat product, such as in an amount of at least 90 ppm based on the total weight of the meat product, such as in an amount of at least 100 ppm based on the total weight of the meat product, such as in an amount of at least 125 ppm based on the total weight of the meat product, such as in an amount of at least 150 ppm based on the total weight of the meat product, such as in an amount of at least 175 ppm based on the total weight of the meat product, such as in an amount of at least 200 ppm based on the total weight of the meat product, such as in an amount of at least 225 ppm based on the total weight of the meat product.
in a combined amount of no greater than 2000 ppm based on the total weight of the meat product, preferably in an amount of no greater than 1500 ppm based on the total weight of the meat product, preferably in an amount of no greater than 1000 ppm based on the total weight of the meat product, preferably in an amount of no greater than 800 ppm based on the total weight of the meat product, preferably in an amount of no greater than 600 ppm based on the total weight of the meat product, preferably in an amount of no greater than 500 ppm based on the total weight of the meat product, preferably in an amount of no greater than 400 ppm based on the total weight of the meat product, preferably in an amount of no greater than 300 ppm based on the total weight of the meat product, preferably in an amount of no greater than 200 ppm based on the total weight of the meat product, preferably in an amount of no greater than 100 ppm based on the total weight of the meat product.
in a combined amount of from 10 to 2000 ppm based on the total weight of the meat product, preferably from 25 to 1500 ppm based on the total weight of the meat product, preferably from 50 to 1000 ppm based on the total weight of the meat product, preferably from 50 to 800 ppm based on the total weight of the meat product, preferably from 50 to 600 ppm based on the total weight of the meat product, preferably from 50 to 500 ppm based on the total weight of the meat product, preferably from 50 to 400 ppm based on the total weight of the meat product, preferably from 50 to 300 ppm based on the total weight of the meat product, preferably from 50 to 200 ppm based on the total weight of the meat product, preferably from 50 to 150 ppm based on the total weight of the meat product, preferably from 50 to 100 ppm based on the total weight of the meat product, preferably from 100 to 300 ppm based on the total weight of the meat product, preferably from 150 to 300 ppm based on the total weight of the meat product, preferably from 200 to 300 ppm based on the total weight of the meat product, preferably approximately 225 ppm based on the total weight of the meat product.

The ratio of (i) green tea [Camellia sinensis] and/or green tea [Camellia sinensis] extract to (ii) acerola [Malpighia emarginata] berry and/or acerola [Malpighia emarginata] berry extract, may be determined by one skilled in the art. In one aspect the (i) green tea [Camellia sinensis] and/or green tea [Camellia sinensis] extract and the (ii) acerola [Malpighia emarginata] berry and/or acerola [Malpighia emarginata] berry extract are provided in amounts such that the ratio by weight of catechins provided by (i) to ascorbic acid provided by (ii) is from 100:1 to 1:100, such as from 90:1 to 1:90, such as from 80:1 to 1:80, such as from 70:1 to 1:70, such as from 60:1 to 1:60, such as from 50:1 to 1:50, such as from 40:1 to 1:40, such as from 30:1 to 1:30, such as from 20:1 to 1:20, such as from 10:1 to 1:10, such as from 9:1 to 1:9, such as from 8:1 to 1:8, such as from 7:1 to 1:7, such as from 6:1 to 1:6, such as from 5:1 to 1:5, such as from 4:1 to 1:4, such as from 3:1 to 1:3, such as from 2:1 to 1:3, such as from 1:1 to 1:3, such as from 1:1.5 to 1:2.5, such as approximately 1:2.

In a preferred aspect the (i) green tea [Camellia sinensis] and/or green tea [Camellia sinensis] extract and the (ii) acerola [Malpighia emarginata] berry and/or acerola [Malpighia emarginata] berry extract are provided in amounts such that the ratio by weight of catechins provided by (i) to ascorbic acid provided by (ii) is from 4:1 to 1:4, preferably from 3:1 to 1:3, preferably from 2:1 to 1:3, preferably from 1:1 to 1:3, preferably from 1:1.5 to 1:2.5, preferably approximately 1:2.

The meat product of the present invention after preparation is typically packed in a commercial packaging suitable for distribution to the end consumer. This packaging may be any suitable packaging known to one skilled in the art. However the present invention also envisages applying the active materials (b) and (c) to a meat product displayed on a counter, for example at a butchers, for sale to a consumer. In such a setting, the meat is then typically wrapped and given to the consumer.

In one aspect the meat product is packaged under a standard atmosphere. It will be appreciated that this means an atmosphere at a pressure and with gas constituents equivalent to a normal atmosphere.

In one aspect the meat product is packaged under a modified atmosphere. Modified atmospheres include atmospheres with enhanced oxygen levels (such as those having greater than 40% oxygen, such as from 40 to 80% oxygen and typically the remainder of the gas consists of carbon dioxide and optionally nitrogen. atmospheres with decreased oxygen levels (such as those having no greater than 2% oxygen, such as no greater than 1% oxygen, such as no greater than 0.5% oxygen, such as no greater than 0.2% oxygen, such as no greater than 0.1% oxygen, such as no greater than 0.05% oxygen, such as no greater than 0.02% oxygen, and such as no greater than 0.01% oxygen), atmospheres high in nitrogen (such as those having no greater than 80% nitrogen, such as from 65 to 70% nitrogen; optionally such enhanced nitrogen atmospheres contain at least 20% carbon dioxide), atmospheres high in carbon dioxide (such as those having from 15 to 40% carbon dioxide, such as from 20 to 40% carbon dioxide), atmospheres high in carbon monoxide (such as those having from 0.1 to 0.5% carbon monoxide, such as from 0.2 to 0.5% carbon monoxide, such as from 0.2 to 0.4% carbon monoxide) and other known modifications. In one aspect the modified atmosphere contains oxygen in an amount of less than 2%, such as oxygen in an amount of less than 1%, such as no greater than 0.5% oxygen, such as no greater than 0.2% oxygen, such as no greater than 0.1% oxygen, such as no greater than 0.05% oxygen, such as no greater than 0.02% oxygen, and such as oxygen in an amount of less than 0.% 0.01%. In one preferred aspect the meat product is packaged under an atmosphere in which there is provided an oxygen scavenger.

The meat product of the present invention may contain one or more additional components. However, in some aspects the meat product of the present invention contains no additional components or contains no additional components that materially affect the properties of the composition.

The meat product of the present invention may further comprise one or more additional components. In one preferred aspect the meat product further may comprise a (further) plant extract. Preferably the further plant extract is selected from hops extract (including alpha and beta acids, humolones and lupolones), vanillin, cinnamon extract (including trans cinnamic aldehyde), pinbark extract, grape extract, grape seed extract, orange extract, plum extract, camu camu extract (Myrciaria dubia), resveratrol, pinosylvin, horse chestnut, yucca extract, pomegranate, acai, bilberry and citrus bioflavonoids.

As discussed herein in one aspect the present invention provides a process for preventing or inhibiting the discoloration of uncooked meat, the process which may comprise the step of contacting (a) uncooked meat; with (b) acerola [Malpighia emarginata] berry, acerola [Malpighia emarginata] berry extract or mixtures thereof; and (c) green tea [Camellia sinensis], green tea [Camellia sinensis] extract or mixtures thereof.

In one aspect the contact of the meat with (b) and (c) is simultaneous. In one aspect the contact of the meat with (b) and (c) is sequential. In respect of sequential contact, the meat may be first brought into contact with (b) and then brought into contact with (c) or the meat may be first brought into contact (c) and then brought into contact with (b). In one preferred aspect (b) and (c) are mixed together and subsequently contacted with the meat.

In the process of the present invention, each of (b) and (c) may be delivered in any suitable manner. In one aspect one of (b) and (c) is provided in a buffer. Preferably at least (b) is provided in a buffer. Preferably at least (c) is provided in a buffer. In one preferred aspect (b) and (c) are mixed together and provided in a buffer. Preferably the buffer has a pH from 5 to 7. Preferably the buffer has a pH from 5.5 to 6.5. Preferably the buffer has a pH from 5.8 to 6.2. Preferably the buffer has a pH from 5.9 to 6.1. Preferably the buffer has a pH of about 6. In one aspect both of (b) and (c) are provided in a buffer. Preferably both of (b) and (c) are provided in a buffer having a pH of from 5 to 7. Preferably both of (b) and (c) are provided in a buffer having a pH from 5.5 to 6.5. Preferably both of (b) and (c) are provided in a buffer having a pH from 5.8 to 6.2. Preferably both of (b) and (c) are provided in a buffer having a pH from 5.9 to 6.1. Preferably both of (b) and (c) are provided in a buffer having a pH of about 6. In an alternative the buffer has a pH from 7 to 11.

It is particularly preferred to buffer the acerola [Malpighia emarginata] berry, acerola [Malpighia emarginata] berry extract or mixtures thereof; and/or the green tea [Camellia sinensis], green tea [Camellia sinensis] extract or mixtures thereof in a buffer selected from a citrate salt, for example sodium citrate or calcium citrate, a carbonate salt, for example sodium carbonate or calcium carbonate, or a hydroxide salt, for example magnesium hydroxide, sodium hydroxide or potassium hydroxide.

In the process of the present invention, each of (b) and (c) may be delivered in any suitable manner. In the process of the present invention, each of (b) and (c) may be delivered in a suitable carrier. In one aspect one of (b) and (c) is dispersed in propylene glycol. In one aspect both of (b) and (c) are dispersed in propylene glycol.

It will be understood by one skilled in the art that the burden of the meat processor may be reduced by providing an additive composition which may comprise (b) and (c) and wherein the composition containing (b) and (c) is brought into contact with the uncooked meat.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### EXAMPLES

The present work was designed to study the effects in ground beef of a combination of green tea extract and acerola extract is respect of fresh colour maintenance. In particular the present study was designed to identify any synergistic interaction between green tea extract and acerola. Thus in the present study green tea extract and acerola were tested and the combination of the two were then tested at half of the concentration level when added separately.

### Example 1

### Experimental

Acerola extract was obtained from A. M. Todd. The extract contained ascorbic acid in an amount of 0.54 wt %. The acerola extract was buffered to a pH of 6.0 by adding a 10% solution of Sodium Carbonate in water (w:w).

The green tea extract used was a standardized green tea extract containing Catechins in the amount of 75 wt. % based on the total weight of the green tea extract. The standardized green tea extract contained green tea extract dispersed in propylene glycol. The standardized green tea extract is available from DuPont (formerly Danisco A/S, Denmark) as Article no. E1220393.

Four treatments were included in the study to measure fresh colour maintenance over time.

The “control” treatment had no ingredients added to the ground beef.

“Green Tea” was a blend of standardized Green Tea Extract and propylene glycol used at an inclusion rate of 0.2% of the total weight of the meat to deliver 450 ppm green tea catechins.

“Acerola” was a liquid blend acerola extract and buffer solution used at 0.2% of total weight of the meat to deliver 10.8 ppm of ascorbic acid.

“Green Tea+Acerola” was a blend of green tea extract and acerola extract in a buffered solution used at 0.4% of the total weight of the meat to deliver 225 ppm green tea Catechins and 5.4 ppm of ascorbic acid.

TABLE 1
Ingredient formulation based on percent in finished product.

| | | Green Tea | Acerola | Green Tea + |
|---|---|---|---|---|
| Test Sample | Control | (wt %) | (wt %) | Acerola (wt %) |
| GTE 75 | 0.00% | 0.06% | 0.00% | 0.03% |
| Buffered Acerola | 0.00% | 0.00% | 0.20% | 0.10% |
| Extract | | | | |
| Propylene Glycol | 0.00% | 0.14% | 0.00% | 0.07% |
| Beef Trim 80% Lean | 100.00% | 99.80% | 99.80% | 99.80% |

In each of the test examples, the active ingredients were dispersed in propylene glycol such that the amount of additive composition totaled 0.2 wt % in each test.

Detailed in Table 1, the concentration on ascorbic acid from Acerola and green tea catechins from Green Tea Extract are reduced by 50% in the Green Tea+Acerola blend.

### Procedure:

Ground beef, 80% lean, was purchased in 10 pound chubs from a grocery store. The treatments were mixed into the ground beef using a Hobart mixer and then formed into patties using a patty press. The patties were placed on #2 styrofoam trays and then over wrapped. Initial Minolta Colorimeter readings were taken and then patties were placed in a 36° F. lighted retail display case. Lights in the retail display case remained turned on for the remainder of the shelf life. Minolta Colorimeter readings were taken daily to measure color maintenance over the products shelf life.

Meat colour a* values were obtained using a Konica Minolta Spectrophotometer CM-770d. Readings were taken using a D65 light source and SCI measurement mode. The multi-measurement setting was used to average six successive readings per patty. A total of 8 patties were evaluated per trial.

Clear PVC overwrap film was pressed to the surface of the patty and measurements were taken through overwrap film.

Samples were kept in a 36°-40° F. [2-4° C.] retail display case. The display case was constantly illuminated with 25 watt Sylvania Octron Eco bulbs that produced a color temperature of 3500 Kelvin. A lux meter was used to measure the foot-candles of light at the meat's surface which produced a mean average of 101 foot candles.

### Results

TABLE 2

| | Control | GTE | Acerola | GTE + Acerola |
|---|---|---|---|---|
| 0 | 15.10 | 14.94 | 15.29 | 14.26 |
| 1 | 12.96 | 12.41 | 13.36 | 12.97 |
| 2 | 8.57 | 7.86 | 9.26 | 10.80 |
| 3 | 5.38 | 4.96 | 5.68 | 6.74 |

TABLE 3
ANOVA

| Source of | | | | | | |
|---|---|---|---|---|---|---|
| Variation | SS | df | MS | F | P-value | F crit |
| Days in Case | 1403.954 | 3 | 467.9845 | 1078.31 | 9.04E−74 | 2.699393 |
| Treatments | 20.85842 | 3 | 6.952808 | 16.02036 | 1.6E−08 | 2.699393 |
| Interaction | 31.85901 | 9 | 3.53989 | 8.156462 | 6.58E−09 | 1.978861 |
| Within | 41.66383 | 96 | 0.433998 | | | |
| Total | 1498.335 | 111 | | | | |

### Discussion

The graph reveals that the control treatment had a high a* value than the green tea treatment. The statistical data shows that there is a p-value of 9.04E-74<0.0001 which relays that there is a large statistical difference in a* values from day to day. This is clearly understood as Applicants expect the ground beef to fade in colour as shelf life increases. The P-value for the individual treatments is 1.6E-08. This shows that there is a statistical difference between the individual treatments.

Furthermore, the computed F value of 8.156 exceeds the F critical value of 1.979 so it is concluded that there is a statistically significant positive interaction effect. The combination of acerola extract and green tea extract demonstrate synergy in respect of prevention or reduction of discoloration.

### Example 2

This study demonstrates the synergistic interaction between green tea extract and acerola extract buffered to a pH of 6.0

### Introduction:

Acerola extract powder was obtained from Diana Food. Green Tea Extract powder was obtained from DuPont (formerly Danisco A/S, Denmark).

Blend #1 was composed of acerola extract powder and propylene glycol buffered to a pH of 6.0 by adding a 5 Normal solution of Sodium Hydroxide. Blend #2 was composed of green tea extract powder and propylene glycol buffered to a pH of 6.0 by adding a 5 Normal solution of Sodium Hydroxide. Blend #1 and #2 were added in proportions according to the mixture design (see table 4). The ingredients are formulated to deliver 3000 ppm in finished product (see table 5).

Four treatments were included in the study to measure fresh color maintenance over time. The control treatment had no ingredients added to the ground beef. “Green Tea” had GTE75 with an inclusion rate of 0.06% in finished product and carried in propylene glycol to aid in dispersion. “Acerola” had buffered acerola extract at 0.2% in finished product with no additional carrier because the buffered acerola extract was already in a liquid state. “Green Tea+Acerola” had GTE75 at 0.03% FP combined with buffered acerola extract at 0.1% FP and propylene glycol to aid in dispersion.

TABLE 4
Mixture Design

| | Trial 1 | Trial 2 | Trial 3 | Trial 4 | Trial 5 | Trial 6 |
|---|---|---|---|---|---|---|
| Blend #1 | 0 | 100% | 0% | 50% | 75% | 25% |
| Blend #2 | 0 | 0% | 100% | 50% | 25% | 75% |
| Total | 0 | 100% | 100% | 100% | 100% | 100% |

TABLE 5
Ingredients in Finished Product (ppm)

| | Trial 1 | Trial 2 | Trial 3 | Trial 4 | Trial 5 | Trial 6 |
|---|---|---|---|---|---|---|
| Acerola Extract | 0 | 600 | 0 | 300 | 450 | 150 |
| Powder | | | | | | |
| Green Tea | 0 | 0 | 133 | 66.5 | 33.25 | 99.75 |
| Extract | | | | | | |
| Powder | | | | | | |
| Propylene | 0 | 2400 | 2867 | 2633.5 | 2516.75 | 2750.25 |
| Glycol | | | | | | |
| Total | 0 | 3000 | 3000 | 3000 | 3000 | 3000 |

### Procedure:

Treatments were added to 80% lean ground beef that was purchased from the grocery store with 14 days age. The treatments were mixed into the ground beef using a Hobart mixer then ground through a grinder with a 3 mm plate. The treatments were formed into patties using a patty press and then placed on #2 styrofoam trays and then over wrapped with oxygen permeable film. Samples were stored in a 4° C. lighted retail display case. Lights in the retail display case remained on for the remainder of the shelf life. Minolta Colorimeter readings were taken daily to measure color maintenance over the products shelf life.

### Results:

TABLE 6

| | Trial 1 | Trial 2 | Trial 3 | Trial 4 | Trial 5 | Trial 6 |
|---|---|---|---|---|---|---|
| 0 | 14.04 | 14.42 | 14.01 | 14.16 | 14.11 | 14.19 |
| 1 | 11.91 | 13.27 | 11.92 | 12.57 | 12.58 | 12.04 |
| 2 | 10.35 | 13.26 | 10.73 | 12.38 | 12.59 | 11.52 |
| 3 | 8.40 | 12.66 | 9.89 | 11.95 | 12.52 | 11.22 |
| 4 | 5.70 | 11.46 | 8.58 | 11.00 | 11.76 | 9.88 |
| 5 | 4.89 | 11.46 | 7.59 | 10.88 | 11.19 | 9.06 |
| 6 | 4.45 | 9.83 | 6.62 | 9.55 | 10.12 | 7.64 |
| 7 | 4.40 | 9.20 | 5.99 | 8.53 | 9.42 | 6.78 |
| 8 | 4.35 | 8.24 | 5.38 | 7.33 | 8.42 | 6.04 |

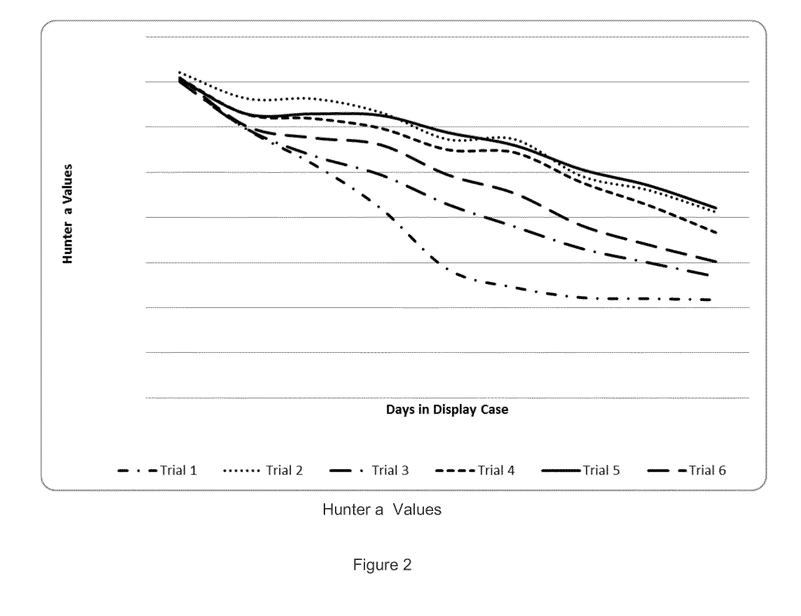

Treatments were analyzed according to the proportion levels of components. A mixture design was utilized to create inverse proportions of the two components. The results are shown in FIG. 2.

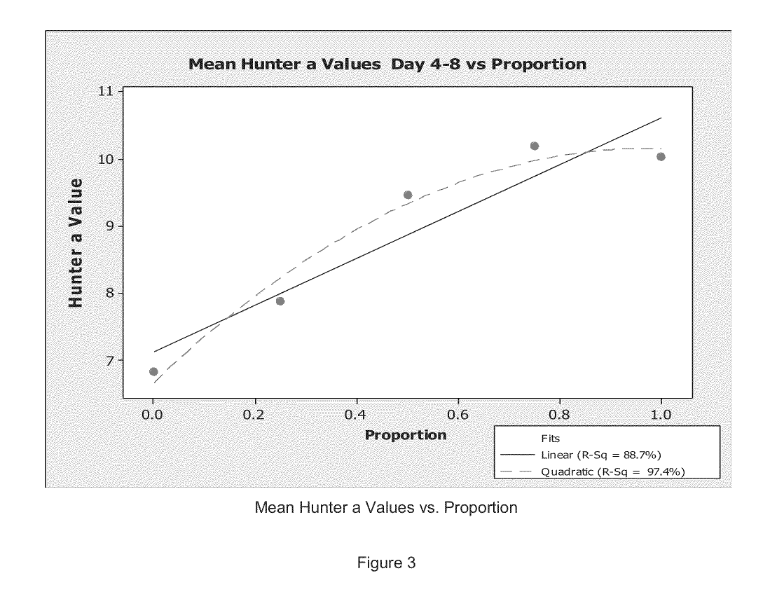

FIG. 3 indicates the synergistic interaction of the components. The combination of both components always equal 100%. The r-square of the linear regression explains 88.7% of the variability whereas the r-square of the quadratic regression explains 97.4% of the variability. The quadratic regression has a better fit to the data that was collected from the trial. Since the regressions are not parallel, there is an interaction that is taking place. There is a strong positive interaction around the proportion of 0.5 which indicates a positive interaction of acerola extract and green tea extract. This relates to the blend ratio of 50% acerola extract and 50% green tea extract performing the best for this application.

### Example 3

### Introduction

Acerola extract powder was obtained from Diana Food. Green Tea Extract powder was obtained from DuPont (formerly Danisco A/S, Denmark).

A study was conducted to further understand acerola extract and green tea extract synergism in respect of color maintenance in fresh ground beef. An individual treatment of acerola extract, labelled component A, was tested at 450 ppm in fresh ground beef. A separate treatment of green tea extract, labelled component B, was tested at 33.25 ppm in fresh ground beef. These two treatments were subtracted from the control treatment which contained no antioxidants and then were added together to get a mean Hunter a Value difference from control. A final treatment, labelled Blend, was prepared which delivered a blend of 450 ppm acerola extract and 33.25 ppm green tea extract to fresh ground beef. A hypothesis test was conducted to determine if there was significant difference between the Hunter a value difference of the Blend and Individual Components added together

Ho:μ_{Blend-Control}=(μ_{Component A-Control})+(μ_{Component B-Control})

### Procedure:

Treatments were added to 80% lean ground beef that was purchased from the grocery store with 14 days age. The treatments were mixed into the ground beef using a Hobart mixer then ground through a grinder with a 3 mm plate. The treatments were formed into patties using a patty press and then placed on #2 styrofoam trays and then over wrapped with oxygen permeable film. Samples were stored in a 4° C. lighted retail display case. Lights in the retail display case remained on for the remainder of the shelf life. Minolta Colorimeter readings were taken daily to measure color maintenance over the products shelf life.

### Results:

TABLE 7

| | Trial 1 | Trial 5 | Trial 1 | Trial 8 |
|---|---|---|---|---|
| Acerola Extract Powder | 0 | 450 | 450 | 0 |
| Green Tea Extract Powder | 0 | 33.25 | 0 | 33.25 |
| Propylene Glycol | 0 | 2516.75 | 2550 | 2966.75 |
| Total | 0 | 3000 | 3000 | 3000 |

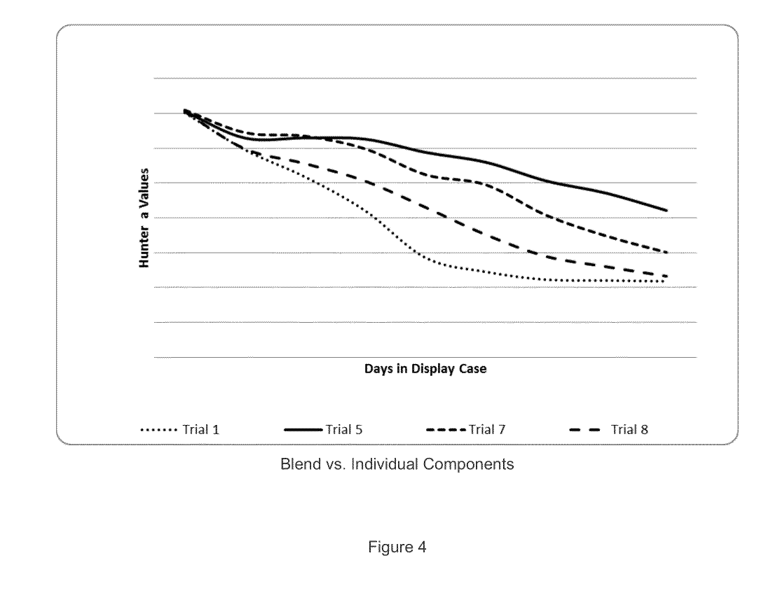

FIG. 4 displays the Hunter a values for the blend vs. the individual components. The blend has a higher Hunter a value after day 3, which is important for shelf life extension.

TABLE 8

| | | | | Component | |
|---|---|---|---|---|---|
| | | | | A + | |
| | Blend - | Component | Component | Component | |
| | Control | A - Control | B - Control | B | p-value |
| 0 | 0.07 | 0.15 | 0.06 | 0.21 | 0.3577 |
| 1 | 0.68 | 0.99 | 0.06 | 1.05 | 0.1401 |
| 2 | 2.25 | 2.35 | 0.77 | 3.12 | 0.0250 |
| 3 | 4.12 | 3.56 | 1.71 | 5.27 | 0.0010 |
| 4 | 6.06 | 4.78 | 2.90 | 7.67 | 0.0002 |
| 5 | 6.30 | 5.01 | 2.14 | 7.14 | 0.0039 |
| 6 | 5.68 | 3.71 | 1.34 | 5.04 | 0.0292 |
| 7 | 5.02 | 2.55 | 0.79 | 3.34 | 0.0002 |
| 8 | 4.07 | 1.66 | 0.30 | 1.96 | 0.0000 |

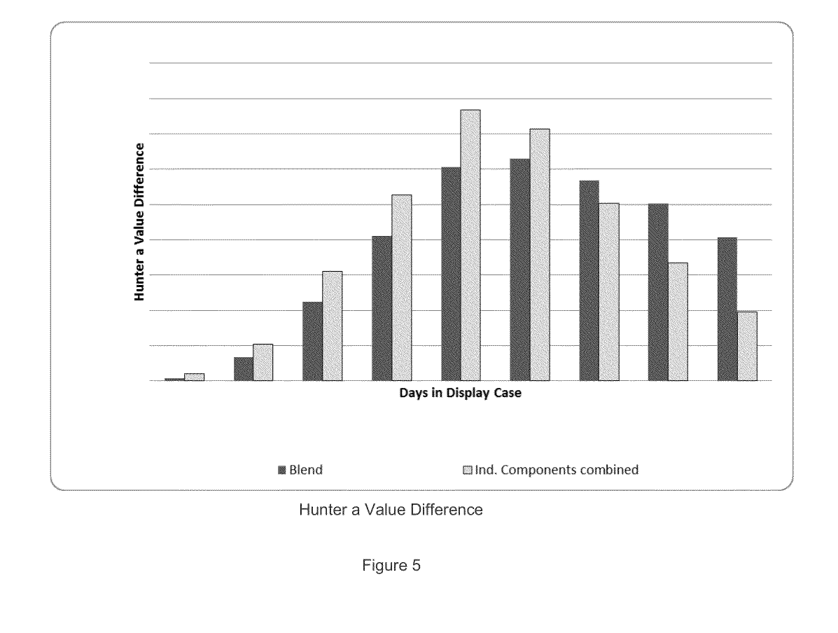

FIG. 5 details the difference in Hunter a values from the control treatment. The difference is the greatest at day 4 as that is the point in the shelf life where the treatments have the largest difference in Hunter a value from the control. On day 6, 7 & 8 the blend has a higher Hunter a value than the individual components combined which indicates that there is a synergistic interaction when the components are added together in the blend. The p-value from the chart shows that there is a significant difference on day 2 through 8. On day 2 through 5, there is a significant difference that Applicants can say the individual components added together have a higher Hunter a value than the blend. On day 6 through 8, there is a significant difference which Applicants can say that the blend has a higher Hunter a value than the individual components added together. Since Applicants are wanting to increase the shelf life of the fresh ground beef, the Hunter a values at the end of the shelf life are more important than at the beginning of the shelf life.

### Example 4

### Effects of pH on Antioxidant Blend

### Introduction:

This study was conducted to investigate if pH has an effect on color stability performance in fresh ground beef.

### Procedure:

Vacuum packed beef Chuck roll sub-primals were purchased from the grocery store with 12 days age from the pack date. The beef Chuck roll was ground through a ½″ plate and mixed to achieve a uniform blend. The ground chuck was then split into 3 batches for individual treatments.

The ½″ ground chuck was mixed in a paddle mixer for 3 minutes with designated treatment shown in Table 4. The blend was then transferred to the grinder for the final grind through a ⅛″ plate. The samples were made into ground beef patties and placed on trays. The trays were immediately over-wrapped and divided into two sets. The first set was stored in the retail display case. The second set was MAP packaged in a masterbag with 64.6% oxygen/35% CO2/0.4% CO gas mixture. The master bags were placed in refrigerated cooler at 2° C. for 18 days.

TABLE 9
Formulation

| Ingredient Name | Unit | Trial 9 | Trial 10 | Trial 11 |
|---|---|---|---|---|
| Ground Beef 85/15 | % | 100.00 | 99.70 | 99.70 |
| Non-Buffered Acerola/ | % | 0.00 | 0.30 | 0.00 |
| Green Tea Blend | | | | |
| Buffered Acerola/ | % | 0.00 | 0.00 | 0.30 |
| Green Tea Blend | | | | |
| Total | % | 100.00 | 100.00 | 100.00 |

A non-buffered blend used maltodextrin as a carrier. A buffered blend was prepared containing magnesium hydroxide as a preferred carrier. The MgOH provided ability for the acerola extract power to dissolve in propylene glycol and provide a pH increase of the final blend. The MgOH acerola extract powder had a pH of 5.15 in a 5% solution in water. Sodium hydroxide was used to increase the -buffered blend to a pH target of 6.0.

Acerola extract powder was obtained from Diana Food. Green Tea Extract powder was obtained from DuPont (formerly Danisco A/S, Denmark).

Samples from the first set were measured each consecutive day using the Konica Minolta Colorimeter to monitor color stability.

On day 18, samples from the second set were removed from the masterbag and placed in the retail display case for the remainder of the shelf life. Minolta colorimeter readings were taken every 24 hours to monitor color stability. Pictures were taken over time to visually monitor color fade of the treatments.

### Results:

TABLE 10
Hunter a* Values

| | | Non-buffered | Buffered |
|---|---|---|---|
| Days in | Control | Blend | Blend |
| Display Case | Trial 9 | Trial 10 | Trial 11 |
| 0 | 13.46 | 15.01 | 14.97 |
| 1 | 9.45 | 10.81 | 12.06 |
| 2 | 3.57 | 6.28 | 10.39 |
| 3 | 2.39 | 2.46 | 7.34 |
| 4 | 2.36 | 2.16 | 3.71 |

According to Table 10, the buffered blend of acerola and green tea extract outperformed the non-buffered blend of acerola and green tea extract on Hunter a values.

The intention of this study was to discover if there was a significant difference between non-buffered vs. buffered blends, so a t-test was performed on Trial 2 and Trial 3. See FIG. 3.

TABLE 11
t-test results

| Days in | Trial 2 | Trial 3 | | |
|---|---|---|---|---|
| Display Case | Mean | Mean | n | p-value |
| 0 | 15.01 | 14.97 | 8 | 0.8468 |
| 1 | 10.81 | 12.06 | 8 | <0.0002* |
| 2 | 6.28 | 10.39 | 8 | <0.0002* |
| 3 | 2.46 | 7.34 | 8 | <0.0002* |
| 4 | 2.16 | 3.71 | 8 | <0.0002* |

*indicated significant difference between means

On days 1-4, the p-value indicates a strong significant difference between the non-buffered and buffered blends. Day 0 was the only day that did not show a significant difference. This was expected as the Minolta color readings were taken immediately after the beef patties were removed from the Low Oxygen-CO masterbag.

### CONCLUSION

The data received from this study confirms a significant difference (p<0.05) of Hunter a* values between trials utilizing non-buffered and buffered blends. Increasing the pH of the blend to a target pH of 6.0 improves the antioxidant's ability to maintain fresh color in ground beef, packaged in a Low Oxygen-CO masterbag.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the following claims.

The invention is further described by the following numbered paragraphs:

1. A meat product comprising
(a) uncooked meat;
(b) acerola [Malpighia emarginata] berry, acerola [Malpighia emarginata] berry extract or mixtures thereof; and
(c) green tea [Camellia sinensis], green tea [Camellia sinensis] extract or mixtures thereof.

2. A meat product according to paragraph 1 wherein the uncooked meat is red meat.

3. A meat product according to paragraph 1 wherein the uncooked meat is selected from pork, beef, lamb, chicken, turkey, veal, rabbit, venison, horse, goat, and fish.

4. A meat product according to any one of the preceding paragraphs wherein the uncooked meat is selected from whole muscle, ground muscle or minced muscle.

5. A meat product according to any one of the preceding paragraphs wherein the uncooked meat is minced beef.

6. A meat product according to any one of the preceding paragraphs wherein the uncooked meat is beef having a fat content of less than 30 wt. % based on the weight of the uncooked meat.

7. A meat product according to any one of the preceding paragraphs comprising acerola [Malpighia emarginata] berry extract.

8. A meat product according to any one of the preceding paragraphs comprising acerola [Malpighia emarginata] berry extract in an amount to provide ascorbic acid in an amount of least 1 ppm based on the total weight of the meat product.

9. A meat product according to any one of the preceding paragraphs comprising acerola [Malpighia emarginata] berry extract in an amount to provide ascorbic acid in an amount of no greater than 300 ppm based on the total weight of the meat product.

10. A meat product according to any one of the preceding paragraphs comprising green tea [Camellia sinensis] extract.

11. A meat product according to any one of the preceding paragraphs comprising green tea [Camellia sinensis] extract in an amount to provide catechins in an amount of at least 100 ppm based on the total weight of the meat product.

12. A meat product according to any one of the preceding paragraphs comprising green tea [Camellia sinensis] extract in an amount to provide catechins in an amount of no greater than 300 ppm based on the total weight of the meat product.

13. A meat product according to any one of the preceding paragraphs wherein the green tea extract is a tea polyphenol.

14. A meat product according to any one of the preceding paragraphs wherein the green tea extract is a catechin.

15. A meat product according to any one of the preceding paragraphs wherein the green tea extract is a compound selected from

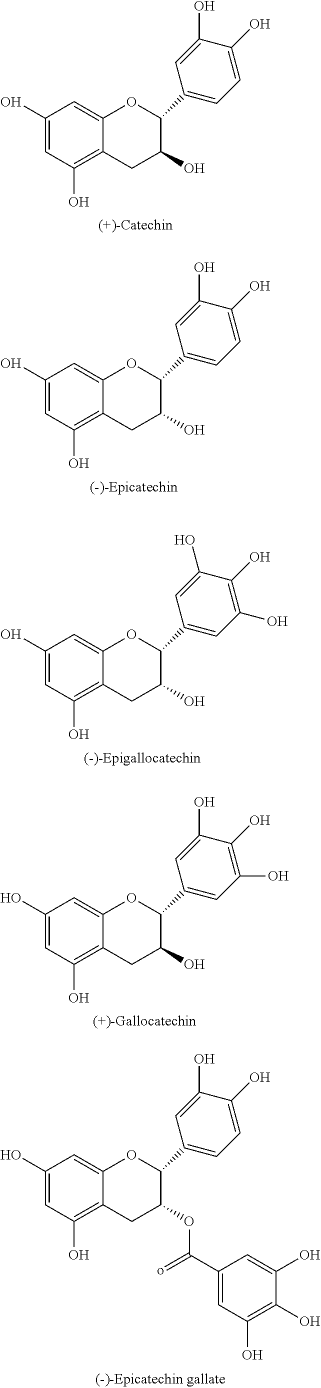

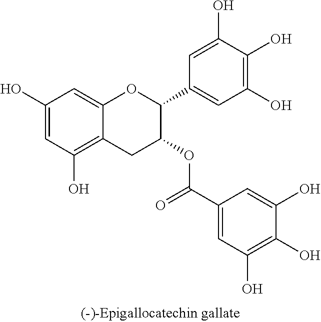 [SMILES: O=C(O[C@@H]1Cc2c(O)cc(O)cc2O[C@@H]1c1cc(O)c(O)c(O)c1)c1cc(O)c(O)c(O)c1]

and mixtures thereof.

16. A meat product according to any one of the preceding paragraphs wherein the meat product is packaged under a modified atmosphere.

17. A meat product according to paragraph 16 wherein the modified atmosphere contains oxygen in an amount of less than 1%.

18. A meat product according to any one of the preceding paragraphs comprising a further plant extract selected from hops extract, vanillin, cinnamon extract, pinbark extract, grape extract, grape seed extract, orange extract, plum extract, camu camu extract (Myrciaria dubia), resveratrol, pinosylvin, horse chestnut, yucca extract, pomegranate, acai, bilberry and citrus bioflavonoids.

19. A process for preventing or inhibiting the discoloration of uncooked meat, the process comprising the step of contacting
(a) uncooked meat;
   with
(b) acerola [Malpighia enmarginata] berry, acerola [Malpighia emarginata] berry extract or mixtures thereof; and
(c) green tea [Camellia sinensis], green tea [Camellia sinensis] extract or mixtures thereof.

20. A process according to paragraph 19 wherein (b) and (c) are contacted simultaneously with the uncooked meat.

21. A process according to paragraph 19 wherein (b) and (c) are contacted sequentially with the uncooked meat.

22. A process according to any one of paragraphs 19 to 21 wherein (b) and/or (c) are provided in a buffer having a pH of from 5 to 7.

23. A process according to any one of paragraphs 19 to 22 wherein (b) and (c) are provided as a composition containing (b) and (c) and wherein the composition containing (b) and (c) is contacted with the uncooked meat.

24. A process according to any one of paragraphs 19 to 23 wherein (b) and/or (c) are dispersed in propylene glycol.

25. A process according to any one of paragraphs 19 to 23 characterised by the features of any one of paragraphs 2 to 18.

26. Use of
(b) acerola [Malpighia emarginata] berry, acerola [Malpighia emarginata] berry extract or mixtures thereof; and
(c) green tea [Camellia sinensis], green tea [Camellia sinensis] extract or mixtures thereof;
   for preventing and/or inhibiting the discoloration of uncooked meat.

27. Use according to paragraph 26 characterised by the features of any one of paragraphs 2 to 18.

28. A meat product as substantially hereinbefore described with reference to any one of the Examples.

29. A process as substantially hereinbefore described with reference to any one of the Examples.

30. A use as substantially hereinbefore described with reference to any one of the Examples.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A meat product comprising
(a) uncooked meat;
(b) acerola [Malpighia emarginata] berry, acerola [Malpighia emarginata] berry extract or mixtures thereof; and
(c) green tea [Camellia sinensis], green tea [Camellia sinensis] extract or mixtures thereof.

2. A meat product according to claim 1 wherein the uncooked meat is red meat.

3. A meat product according to claim 1 wherein the uncooked meat is selected from pork, beef, lamb, chicken, turkey, veal, rabbit, venison, horse, goat, and fish.

4. A meat product according to claim 1 wherein the uncooked meat is selected from whole muscle, ground muscle or minced muscle.

5. A meat product according to claim 1 wherein the uncooked meat is minced beef.

6. A meat product according claim 1 wherein the uncooked meat is beef having a fat content of less than 30 wt. % based on the weight of the uncooked meat.

7. A meat product according to claim 1 comprising acerola [Malpighia emarginata] berry extract.

8. A meat product according to claim 1 comprising acerola [Malpighia emarginata] berry extract in an amount to provide ascorbic acid in an amount of least 1 ppm based on the total weight of the meat product.

9. A meat product according to claim 1 comprising acerola [Malpighia emarginata] berry extract in an amount to provide ascorbic acid in an amount of no greater than 300 ppm based on the total weight of the meat product.

10. A meat product according to claim 1 comprising green tea [Camellia sinensis] extract.

11. A meat product according to claim 1 comprising green tea [Camellia sinensis] extract in an amount to provide catechins in an amount of at least 100 ppm based on the total weight of the meat product.

12. A meat product according to claim 1 comprising green tea [Camellia sinensis] extract in an amount to provide catechins in an amount of no greater than 300 ppm based on the total weight of the meat product.

13. A meat product according to claim 1 wherein the green tea extract is a tea polyphenol.

14. A meat product according to claim 1 wherein the green tea extract is a catechin.

15. A meat product according to claim 1 wherein the green tea extract is a compound selected from 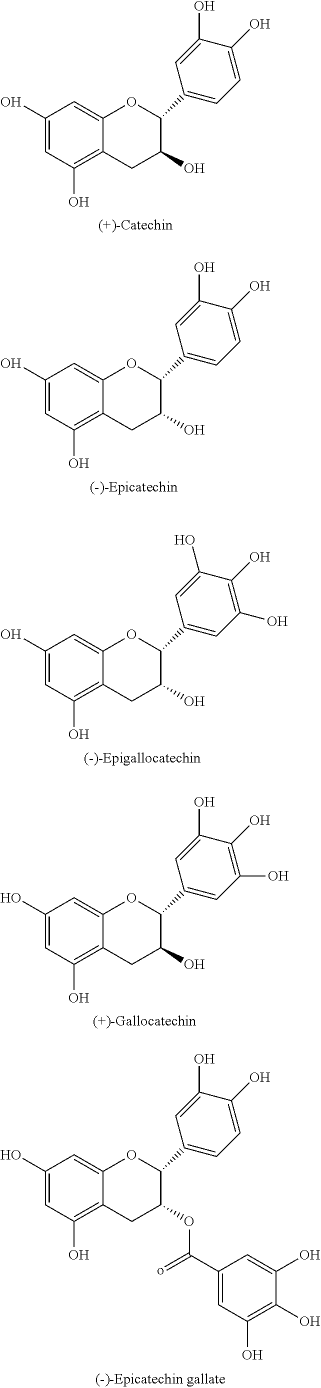 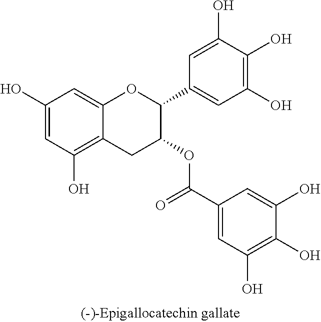 [SMILES: O=C(O[C@@H]1Cc2c(O)cc(O)cc2O[C@@H]1c1cc(O)c(O)c(O)c1)c1cc(O)c(O)c(O)c1]
and mixtures thereof.

16. A meat product according to claim 1 wherein the meat product is packaged under a modified atmosphere.

17. A meat product according to claim 16 wherein the modified atmosphere contains oxygen in an amount of less than 1%.

18. A meat product according to claim 1 comprising a further plant extract selected from hops extract, vanillin, cinnamon extract, pinbark extract, grape extract, grape seed extract, orange extract, plum extract, camu camu extract (Myrciaria dubia), resveratrol, pinosylvin, horse chestnut, yucca extract, pomegranate, acai, bilberry and citrus bioflavonoids.

19. A process for preventing or inhibiting the discoloration of uncooked meat, the process comprising the step of contacting
(a) uncooked meat;
with
(b) acerola [Malpighia emarginata] berry, acerola [Malpighia emarginata] berry extract or mixtures thereof; and
(c) green tea [Camellia sinensis], green tea [Camellia sinensis] extract or mixtures thereof.

20. A process according to claim 19 wherein (b) and (c) are contacted simultaneously with the uncooked meat.

21. A process according to claim 19 wherein (b) and (c) are contacted sequentially with the uncooked meat.

22. A process according to claim 19 wherein (b) and/or (c) are provided in a buffer having a pH of from 5 to 7.

23. A process according to claim 19 wherein (b) and (c) are provided as a composition containing (b) and (c) and wherein the composition containing (b) and (c) is contacted with the uncooked meat.

24. A process according to claim 19 wherein (b) and/or (c) are dispersed in propylene glycol.
